(19) United States
(12) Patent Application Publication
(10) Pub. No.: US 2003/0158610 A1
(43) Pub. Date: Aug. 21, 2003

(54) Control systems for extrusion or drawing plants

(76) Inventor: Mohammad Hafiz Fazal Elahi Jamal-Ahmad, Cranford (GB)

Correspondence Address: CHRISTIE, PARKER & HALE, LLP, 350 WEST COLORADO BOULEVARD, SUITE 500, PASADENA, CA, 91105, US

(21) Appl. No.: 10/239,115

(22) PCT Filed: Mar. 19, 2001
(86) PCT No.: PCT/GB01/01165

(51) Int. Cl. G05B 15/00; G05B 13/02

(52) U.S. Cl. 700/28; 700/1; 700/32

(57) ABSTRACT

A control system for an extrusion plant is produced with the aid of a mathematical model of the plant in question. Having established a mathematical model of the plant, a controller is designed and tested. The establishment of the model based controller enables the plant to be controlled in a more efficient manner by correcting for the effects of disturbances produced while the plant is operating before the effect of these disturbances manifest themselves in the product at the downstream end of the plant.

The present invention relates to a control system for controlling extrusion or drawing plants.

Extrusion plants for coating electrical conductors with electrically insulating material employ a number of sensors to monitor the diameter, the capacitance and wall thickness of the extruded material. In such previously proposed plants a control system responds to the sensors to feed-back control signals to the plant in a sense to keep the diameter capacitance and wall thickness constant. The problem with this system is that there is a delay between the time that the extrusion is actually occurring and the time any irregularity is sensed and as a result the system will tend to oscillate between over and under compensation until a steady state situation is again reached.

Similarly, with drawing plants for drawing optical fibres of quartz or other materials, the control systems have similar problems.

It is an object of the invention to provide an improved control system for an extrusion and drawing plant.

According to the present invention there is provided a method of constructing a control system for a real extrusion or drawing plant comprising the steps of:

a) creating a mathematical model of the plant by exciting the plant actuators and establishing the mathematical relationship between the plant inputs and outputs.

b) creating a mathematical disturbance model to represent the differences between the real plant inputs and the model outputs.

c) using the mathematical model and the disturbance model to create a mathematical model based controller; and

d) using the mathematical model based controller to control the real extrusion or drawing plant.

According to the present invention there is further provided a method of constructing a fault deletion system for an extrusion or drawing plant comprising the steps of:

a) inducing a fault into the plant and detecting the effect on the plant output.

b) creating a mathematical relationship between the fault and the output.

c) monitoring the plant to detect in the plant output a characteristic indicative of the mathematical relationship.

A control system for extrusion and drawing plants and embodying the present invention will now be described, by way of example, with reference to the accompanying diagrammatic drawings in which:

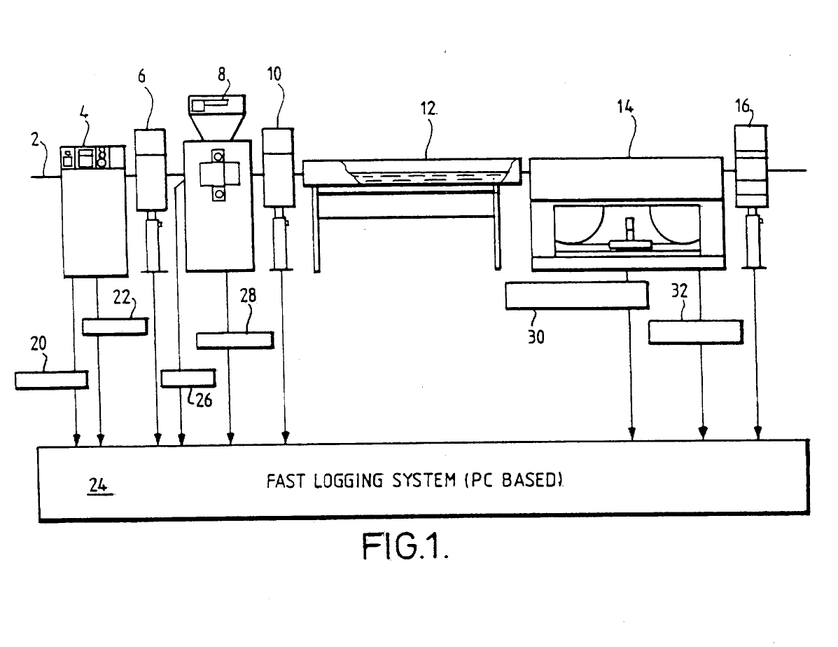

FIG. 1 is front elevation of an extrusion plant;

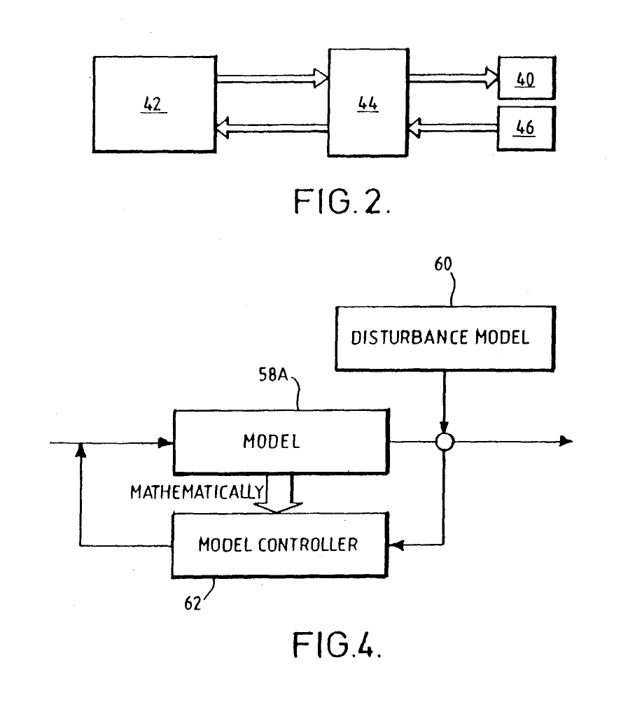

FIG. 2 is a block diagram of a mathematical modelling system;

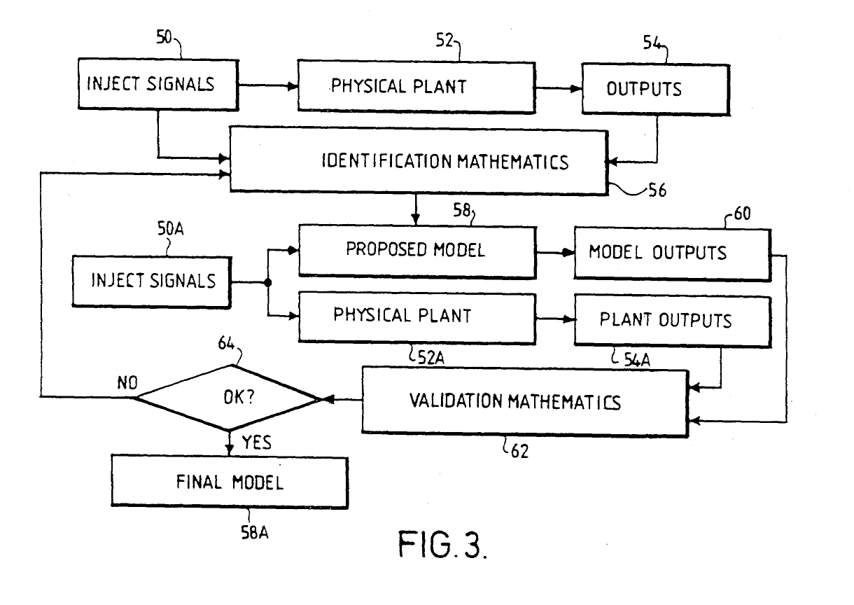

FIG. 3 is a flow chart illustrating the construction of a plant model;

FIG. 4 is a block diagram of a system for constructing a model controller;

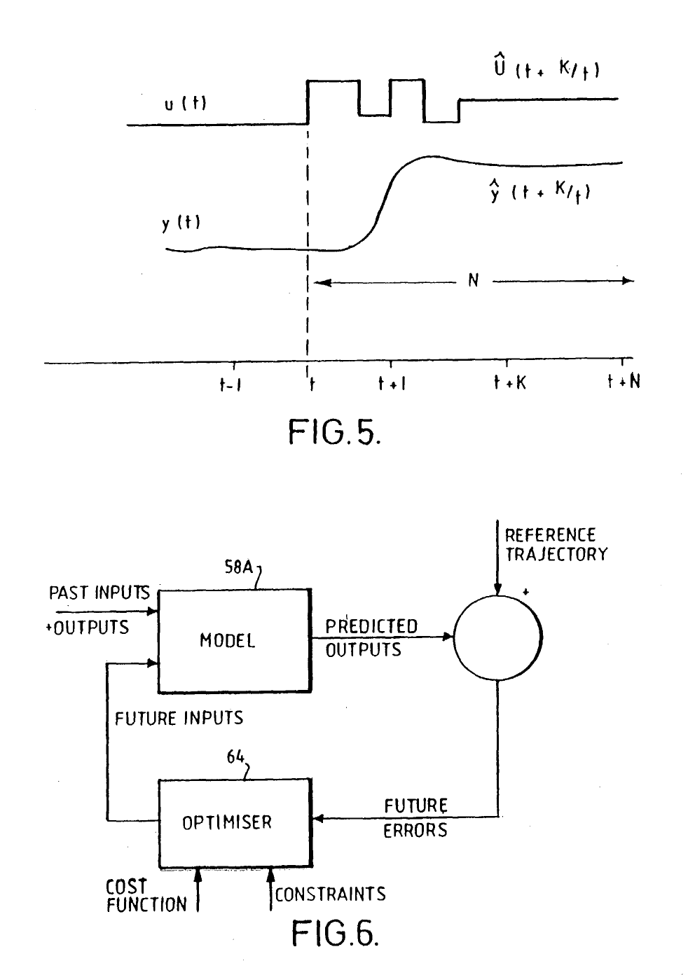

FIG. 5 illustrates graphically the prediction of outputs in response to inputs;

FIG. 6 is block diagram of a model optimiser

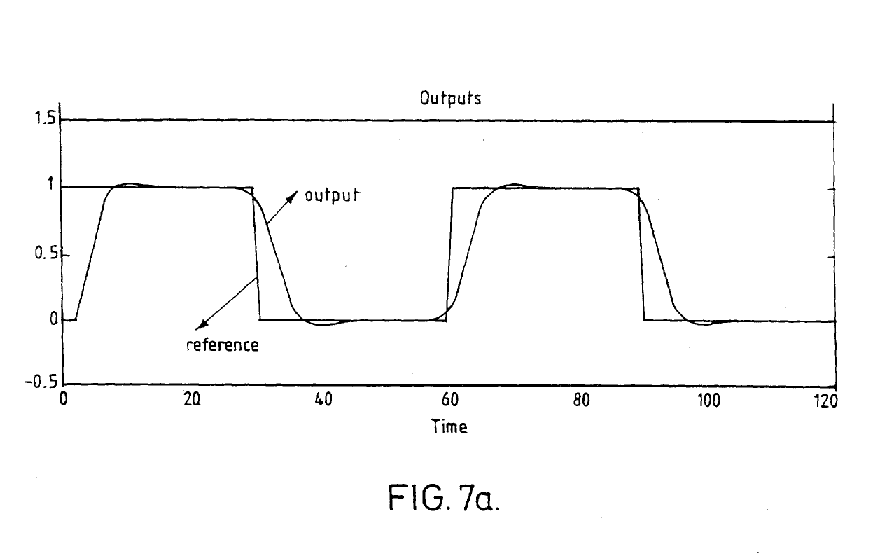

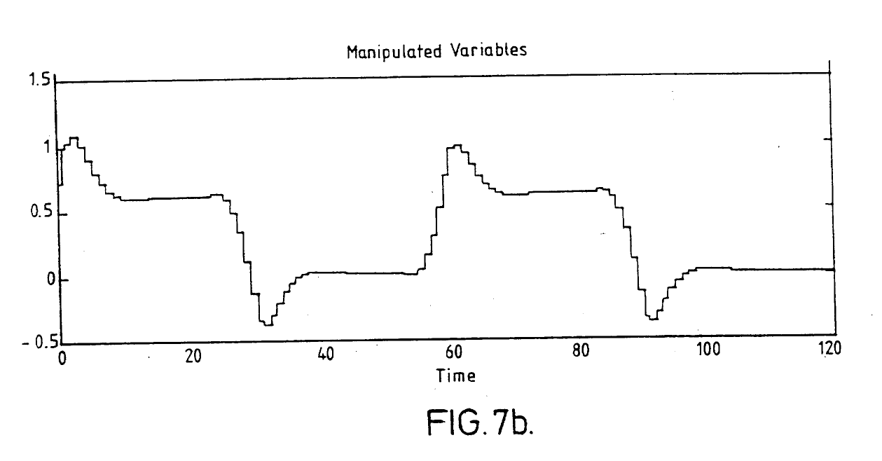

FIG. 7 illustrates graphically the inputs and outputs in a closed loop control system;

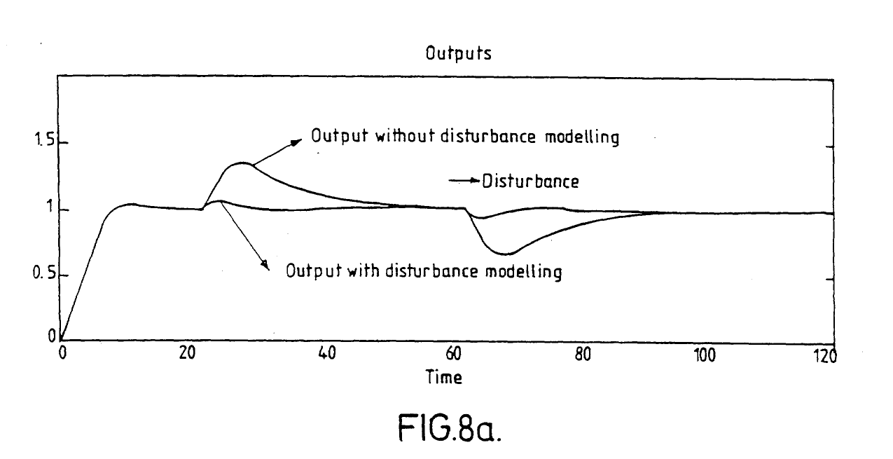

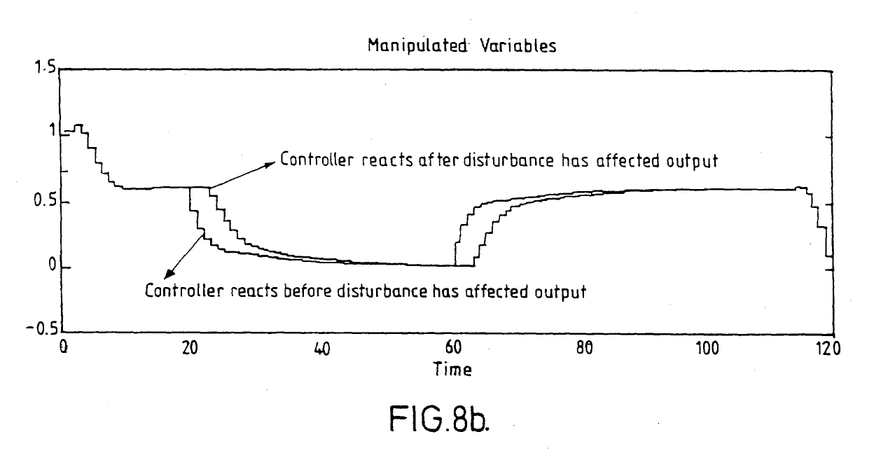

FIG. 8 illustrates graphically the inputs and outputs in a closed loop system both with and without disturbance modelling;

FIG. 9 is a block diagram illustrating the claim of possible faults in the plant model;

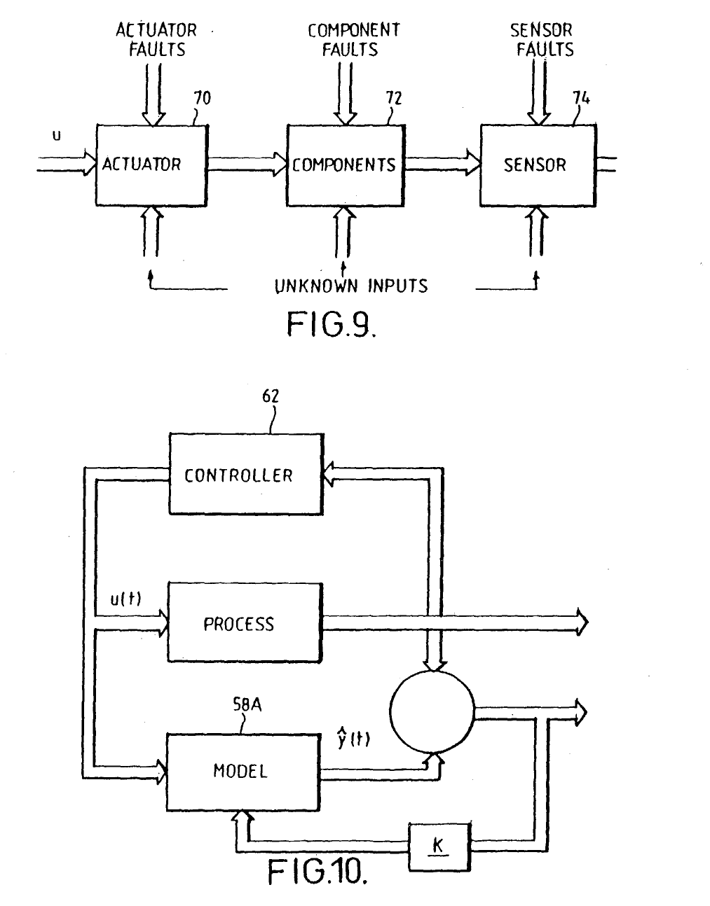

FIG. 10 is a block diagram of a system for processing faults;

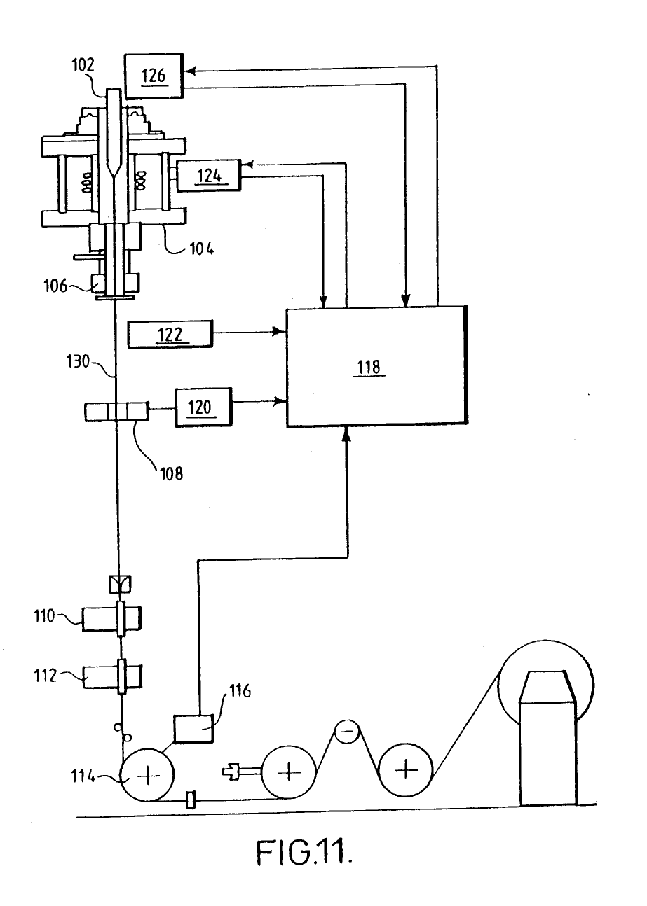

FIG. 11 is a front elevation of a drawing plant; and

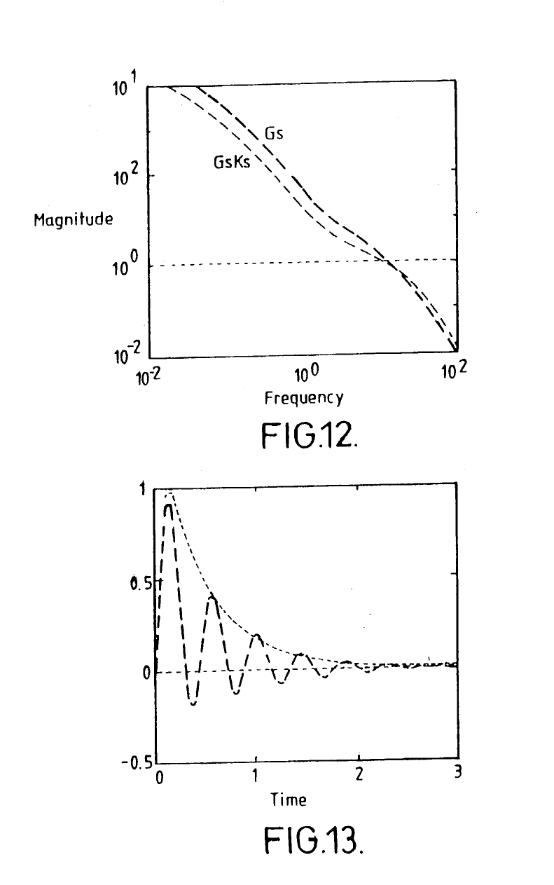

FIGS. 12 and 13 are graphs illustrating the characteristics of the drawing plant of FIG. 11.

In order to construct a control system embodying the present invention we need to construct a mathematical model of the plant in question.

The plant shown in FIG. 1 comprises a plant for producing a high grade data communication single wire coated conductor.

As shown the raw conductor core 2 travels progressively through a tensioning and preheating unit 4, and a diameter measuring device 6 before entering an extruder 8. The coated cable emerging from the extruder 8 then passes through another diameter measuring device 10 following which it travels through an elongate cooling bath 12. The coated cable passes around a driven capstan unit 14 and emerges to pass through a third diameter measuring device 16.

A tension sensor 20 and temperature sensor 22 within the unit 4 respectively feed output signals representing core tension and core temperature to a fast logging system 24. A pressure sensor 26 and a speed sensor 28 within the extruder respectively feed signals representing the melt pressure and the extruder speed to the fast logging unit 24. A capacitance sensor 30 and a capstan speed sensor 32 within the capstan unit 14 respectively feed signals representing the coated core capacitance and the capstan speed to the fast logging system. Finally the three temperature sensors 6, 10 and 16 feed signals respectively representing pre-heat temperature, not diameter temperature and cold diameter temperature to the fast logging system 24.

We now have a system which can monitor changes in downstream parameters produced by changes in upstream parameters.

FIG. 2 is a block diagram of a system for obtaining a mathematical model of the plant of FIG. 1. The plant includes various process actuators for controlling the speed of the core 2, the temperatures generated and the speed of the extruder. Test signals can be sent to these actuators shown as a single block 40 by a modeller 42 through a hardware interface 44. The process sensors which are described in connection with FIG. 1 are shown as a single block 46 and these send signals back to the modeller 42.

The modeller is a software routine which can inject a variety of test signals into the process via the actuators and log the outputs of the process obtained from the sensors. One or more test signals maybe injected simultaneously and one or more outputs logged. Based on these inputs and outputs data, the Modeller can derive linear or non-linear models of the process and the disturbances acting upon it. These models may also be of the parametric or non-parametric types. Some of the test signals are step, impulse, band-limited white noise, pseudo random binary signals, chirp signals and multisines. The modeller can also perform relay feedback tests to find the optimal parameters of PID (Proportional, Integral and Derivative value) controllers and variants of it. The parameters of interest are Diameter, Capacitance, Extruder speed, Capstan speed, Melt pressure, Tension, Extruder Zones Temperature, Eccentricity, Elongation, Wire Temperature, Core Diameter. In the parametric case, the structure and order of the process model and disturbances can be chosen by software based on a based on a priori results of preliminary tests. The modeller can be configured by software to calculate the parameters of the process model and disturbance model at every sampling interval to permit the implementation of an adaptive controller or to calculate the parameters of the process model and disturbance model just once to permit the implementation of a self-tuning controller.

The modeller 42 is used to create a mathematical model for this plant in the manner shown in the flow chart of FIG. 3. In order to reduce the complexity of the modeller it was assumed that the relationship between inputs and outputs were linear and that noise was purely random. As shown test signals 50 were injected into the physical plant 52. The test signals and the outputs 54 of the plant were use to create the proposed mathematical model 58. The injected signals 50A were again fed to the physical plant 52A and also to the proposed model 58. The plant outputs 56A and the model outputs 60 were compared by a validation mathematics and if valid the relevant component of the proposed mathematical model 58 were included in the final model 58. If not valid the identification experiments were repeated until a suitable model was obtained. By using a whole gamut of injected signals the final model 58A was progressively built up.

Once the model has been produced we can design a model based controller 62 (see FIG. 4). Disturbances of the plant including measurement noise are modelled separately in a disturbance model 60.

The model based controller 62 is a software program that incorporates a variety of simple and advanced control algorithms. The simple algorithms are of the Proportional (P), Proportional plus Integral (P1) and Proportional plus Integral plus Derivative (PID) types. The parameters of these simple models are calculated from relay feedback tests performed by the Modeller. The advanced control algorithms are based on model predictive control, the parameters of which are also obtained from the Modeller also minimum variance control and Linear Quadralic Gaussian control (LQG), algorithms are provided based on the Dynamic Matrix Control (DMC) technique and Generalised Predictive Control technique (GPC).

The methodology of all controllers belonging to the Model Predictive Control family is characterised by the following strategy illustrated in connection with FIG. 5 where time t is plotted along the horizontal axis and the input U(t) and the output X(t) are plotted along the vertical axis.

The future outputs y(t) for a determined horizon N, called the prediction horizon, are predicted at each instant t using the process model. These predicted outputs y(t+k|t), for k=1 . . . N depend on the known values of past inputs and outputs up to instant t and the future control signals u(t+k|t), for k=1 . . . N−1 which are those to be sent to the system and to be calculated.

The set of future control signals is calculated by optimising a pre-determined criterion in order to keep the process as close as possible to the reference trajectory w(t+k) (which can be the set point itself or a close approximation to it). This criterion usually takes the form of a quadratic function of the errors between the predicted output signal and the predicted reference trajectory. The control effort is included in the objective function in most cases.

The control signal u(t|t) is sent to the process while the next control signals calculated are rejected, because at the next sampling instant y(t+1) is already known and the future outputs are recalculated using this new information and all the sequences are brought up to date. Thus the u(t+1|t+1) is calculated using the receding horizon concept.

The methodology of Model Predictive Control is depicted in FIG. 6. A model is used to predict the future plant outputs, based on past and current values and on the proposed optimal future control actions. These actions are calculated by an optimiser 64 taking into account the cost function as well as the constraints.

A Dynamic Matrix Control example is illustrated as follows:

The step response of the process is obtained by the Modeller and for a prediction horizon of p=10 and a control horizon of m=5 is arranged in matrix from as:

$$G = [ \begin{matrix}0 & 0 & 0 & 0 & 0 \\ 0.271 & 0 & 0 & 0 & 0 \\ 0.498 & 0.271 & 0 & 0 & 0 \\ 0.687 & 0.498 & 0.271 & 0 & 0 \\ 0.845 & 0.687 & 0.498 & 0.271 & 0 \\ 0.977 & 0.845 & 0.687 & 0.498 & 0.271 \\ 1.087 & 0.977 & 0.845 & 0.687 & 0.498 \\ 1.179 & 1.087 & 0.977 & 0.845 & 0.687 \\ 1.256 & 1.179 & 1.087 & 0.977 & 0.845\end{matrix} ]$$

The disturbance model is given by the Modeller as:

$${G}_{d} ( z ) = \frac{0.05 {z}^{- 3}}{1 - 0.9 {z}^{- 1}}$$

The objective in this example is for reference tracking and disturbance rejection.

As a step response is employed:

$$y ( t ) = {\sum }_{i = 1}^{∞} {g}_{i} Δ u ( t - 1 )$$

where

y(t) is the output

gᵢ is the ith step response coefficient

Δ=(1−z⁻¹)

u(t) is the control signal

The predicted values along the horizon is then given by

$$\hat{y} ( t + k \vert t ) = {\sum }_{i = 1}^{∞} {g}_{i} Δ u ( t = k - i ) + \hat{n} ( t + k \vert t ) = {\sum }_{i = 1}^{k} {g}_{i} Δ u ( t + k - i ) + {\sum }_{i = k + 1}^{∞} {g}_{i} Δ u ( t + k - i ) + \hat{n} ( t + k \vert t )$$

where

y(t+k|t) is the predicted value of y at time t+k given y up to time t

n(t+k|t) is the predicted value of the disturbance n at time t+k given n

The disturbance are considered to be constant in Dynamic Matrix control, that

\hat{n}(t+k|t)=\hat{n}(t|t)=yₘ(t)−ŷ(t|t)

where yₘ (t) is the measured output at time t.

Then it can be written that:

$$\hat{y} ( t + k \vert t ) = {\sum }_{i = 1}^{k} {g}_{i} Δ u ( t + k - i ) + {\sum }_{i = k + 1}^{∞} {g}_{i} Δ u ( t + k - i ) + {y}_{m} ( t ) - {\sum }_{i = 1}^{∞} {g}_{i} Δ u ( t - i ) = {\sum }_{i = 1}^{∞} {g}_{i} Δ u ( t + k - i ) + f ( t + k )$$

where ƒ(t+k) is the free response of the system, that is, the part of response that does not depend on the future control actions and is given by:

$$f ( t + k ) = {y}_{m} ( t ) + {\sum }_{i = 1}^{∞} {g}_{k + i} ( {g}_{k + i} - {g}_{i} ) Δ u ( t - i )$$

For the example being considered the process is asymptotically stable and the coefficients gᵢ of the step response tend to a constant value after N sampling so it can be considered that

gₖ₊ᵢ−gᵢ 0, I>N N=30 in the example

and therefore the free response can be computed as:

$$f ( t + k ) = {y}_{m} ( t ) + {\sum }_{i = 1}^{N} ( {g}_{k + i} - {g}_{i} ) Δ u ( t - i )$$

So the predictions can be computed along the prediction horizon (k=1 . . . p). considering m control actions.

ŷ(t+1|t)=gᵢ(t)+ƒ(t+1)

ŷ(t+2|t)=g₂Δu(t)+g₁Δu(t+1)+ƒ(t+2)

$$\hat{y} ( t + p \vert t ) = {\sum }_{i = 1}^{m} {g}_{i} Δ u ( t + p - i ) + f ( t + p )$$

A simulation of the closed loop control system without disturbance and a square wave reference is shown in FIG. 7. Note that weights in the cost function can be chosen to increase or decrease the speed of response.

A simulation of the closed-loop control system with a step disturbance of magnitude 2 which occurs from t=20 to t=60 with a unit step reference is shown FIG. 8. In the case where the controller explicitly considers the measurable disturbances it is able to reject them, since the controller starts acting when the disturbance appears, not when its effects appears in the output. On the other hand, if the controller does not take into account the measurable disturbances, it reacts later, when the effect on the output is considerable.

The mathematical process model as hereinbefore described, describes the process behaviour under normal operating conditions. In the practical applications, the values of the parameters of the process model are difficult to compute exactly. The uncertainty in the process parameters, disturbances and measurement noise not representing faults can influence measurements and thereby make it more difficult to detect faults.

FIG. 9 is a block diagram showing an actuator 70 receiving an input u, actuator faults and an unknown input. The components 72 within the actuation 70 receive component faults and unknown faults. The outputs of the components 72 are fed to the sensors 76 which in turn receive the sensor faults and unknown faults. Unknown faults include parameter uncertainty, disturbances and measurement noise in order to distinguish them from real faults.

The fault detection algorithm generates a signal which enables a statement to be made about the appearance of a fault. This signal, called the residual, is generated by an observer or filter which computes an estimate of the measured signal y(t) as depicted in FIG. 10. The difference between the measured signal y(t) and the estimated signal y(t) yields the residual.

The residual should be zero in the fault free case and non-zero in the case of a fault. Ideally, a comparison of the residual with zero should yield a decision about the occurrence of a fault. But the unknown inputs mentioned previously produce a residual which in non-zero even in the fault free case. Therefore a threshold other than zero is employed in order to prevent false alarm. This threshold is user selectable by software.

The observer or filter is designed in such a way that faults are de-coupled from the unknown inputs so that the residual is hardly ever affected by them. This method is called robust fault detection in the literature since the residual is then robust against unknown inputs and only sensitive to faults. This concept of de-coupling is also used for isolating different faults from each other. The filter or observer is designed so that it is sensitive to one fault but insensitive to other faults. A filter is designed for each fault which gives a bank of filters or observers. Logical evaluation of their residuals leads to a clear decision as which fault has occurred.

It will be appreciated that the hardware and its interfaces may be realised in many ways, one of which is a Personal Computer with a plug-in D/A (Digital to Analogue) card. The D/A card has its own processor and on board memory.

Also it will be noted that user. interface is a software program which allows the user to set parameters like set-points, tolerance limits on variables and to configure the Modeller and Controller for particular choices of modelling and control techniques. The User Interface also provide graphical displays of important process variables like diameter, capacitance, and others together with tolerance limits set by the user. The program can also perform statistical process control analyses to process variables. Furthermore, the User Interface also provide the user with a powerful spectrum estimation tool which is based on advanced parametric and non-parametric spectrum estimation techniques.

While the control system described has been described in conjunction with extrusion plants for controlling electrical conductors with an insulating coating it will be appreciated that it can be applied to all other types of extrusion plants.

The extrusion plant can extrude solid plastics in which case a plant model having multiple inputs and a single output can be used.

In the case of the extrusion plant extruding foamed plastics the mathematical model of the plant will have both multiple inputs and multiple outputs.

The establishment of a mathematical model of the plant also allows the establishment of a mathematical characteristic of a fault introduced into the real plant so that the subsequent detection of the characteristic in the plant output will allow corrective action to be taken before the fault can cause a failure of this plant.

The drawing plant shown in FIG. 11 is a plant for drawing optical fibres and a control system for controlling the operation of the plant in accordance with the present invention.

As shown, a glass perform 102 is fed into a furnace 124 and drawn through a die a fibre is drawn from the base 106 of the perform 106 by capstan 114 located vertically below the furnace 124. The drawn fibre 130 passes a tension measurement device 122 for measuring the tension in the fibre, a diameter measuring device 108/120 for measuring the diameter of the fibre and a pair of surface coating stations 110 and 112 for providing the fibre with an outer coating before reaching the capstan 114. A capstan speed controller 116 controls the speed of the capstan 114.

A feed control and feed rate detection system 126 controls and measures the feed rate of the perform 102. A heating control and temperature measurement system 124 controls and monitors the temperature of the furnace 104.

A control system 118 controls the operating parameters of the plant in a manner which will be described in more detail hereinafter.

The control system 118 receives signals from the tension measurement device 122, the diameter measuring device 108/120 as well as from the temperature measuring system 124 and the feed rate detection system 126 and responds these to feed control signals to the perform feed control system 126 to the heating control system 124 and to the capstan speed controller 116 in a manner to ensures that the optical fibre 130 drawn lies within a predetermined range of tolerances.

The design of the control system 118 is based on a H-infinity design. H-infinity design is the name given to a family of design methods. For example Mixed Sensitivity H-infinity design, Signal-Based H-infinity design and Robust Loop-Shaping H-infinity design. In the following example, the Robust Loop-Shaping method is applied to control the drawing plant with the objective of minimising the effects of disturbances. The systematic Robust-Loop shaping procedure has its origin in the PhD thesis of Hyde (1991). The procedure was extended to a second-degree-of-freedom in the controller by Limebeer et al (1993).

Given a plant model function G(s) and a disturbance model function G_{d}(s) obtained by system identification or otherwise, the plant is shaped with pre- and post compensators W1 and W2 to obtain the shaped plant function Gₛ(s).

The left (or right) coprime factorisation of the shaped plant function Gₛ(s) is

Gₛ(s)=M⁻¹N

The perturbed plant can then be written as

Gₚ=(M+ [symbol] ₘ)−1(N+ [symbol] _{N})

such that _[ [symbol] _{N}ε_{M}]_{—φ}

where [symbol] _{M} and [symbol] _{N} are stable unknown transfer functions which represent the uncertainty in the nominal plant model and His the stability margin

For the perturbed feedback system, the stability property is robust if and only if the nominal feed back system is stable and

$$ϑ {∋}_{\underline{\_}} {‖ > \begin{matrix}K \\ I\end{matrix} \hat{=} {( I - GK )}^{- 1} {M}^{- 1} ‖}_{φ} \leq \frac{1}{H}$$

where (I−GK)⁻¹ is the sensitivity function for this positive feedback arrangement.

The lowest achievable value of θ and corresponding maximum stability margin Hare given by Glover and McFarlane (1989) as

θₘᵢₙ=Hₘₐₓ¹=(1+Y(XZ))^{1/2}

where Y is the spectral radius and for a minimal state space realisation (A,B,C,D) of Gs(S), Z is the unique positive definite solution to the algebraic Riccati equation

(A−BS⁻¹D^{T}C)Z+Z(A−BS⁻¹D^{T}C)^{T}−ZC^{T}R⁻¹CZ+BS⁻¹B^{T}=0

where R=I+DD^{T}, S=I+D^{T}D

and X is the unique positive definite solution to the following algebraic Riccati equation

(A−BS⁻¹D^{T}C)X+X(A−BS⁻¹D^{T}C)−XBS⁻¹B^{T}X+C^{T}R⁻¹C=0

The central controller in McFarlane and Glover (1990) which guarantees that

∥>_{I}^{K}\hat{=}(I−GK)−1M−1∥_{φ}≦θ

for a specified γ>γₘᵢₙ (usually 10% greater) is given by

$$K = [ \frac{A + BF + {{γ}^{2} ( {L}^{T} )}^{- 1} {ZC}^{T} ( C + DF )}{{B}^{T} X} \vert \frac{{{γ}^{2} ( {L}^{T} )}^{- 1} {ZC}^{T}}{- {D}^{T}} ]$$

F=−S⁻¹(D^{T}C+B^{T}X)

L=(1−γ²)I+XZ

### EXAMPLE

$$Given G ( s ) = \frac{200}{( 10 s + 1 ) {( 0.05 s + 1 )}^{2}} and {G}_{d} ( s ) = \frac{100}{10 s + 1}$$

Let the objective be to get as good disturbance rejection as possible and the gain crossover frequency for the final design to be about 10 rad/s.

The appropriate weights are

$$W2 = 1 and W1 = \frac{S + 2}{S}$$

This yields the shaped plant Gₛ(S)=GW2=1 and

$$W1 = \frac{200 ( s + 2 )}{( 10 s + 1 ) {( 0.05 s + 1 )}^{2}}$$

Applying the Glover McFarlane algorithm the controller is obtained as

$$K = \frac{143.6 {s}^{4} + 6488 {s}^{3} + 8.585 {e4s}^{2} + 2.508 e5s + 2.078 e5}{{s}^{5} + 126.8 {s}^{4} + 5810 {s}^{3} + 1.329 {e5s}^{2} + 2.433 e5s + 24.22}$$

The graph shown in FIG. 12 illustrates the frequency response of the shaped plant Gs(s) in dotted lines and that of the robustified plant Gs(s) K(s). It is seen that the slope of Gs(s) K(s) around the crossover frequency is much gentler than that of Gs(s). This translates into better margins. The graph of FIG. 13 illustrates the time domain response to a unit step disturbance. The disturbance is driven down to zero in about 2 seconds and it stays below 1 for all time. This shows that for a properly scaled plant and disturbance model the distance stays bellows the level we are prepare to tolerate at all times.

It will be appreciated that while the H-infinity design method is described in connection with the fibre drawing plant, it can equally be applied to the extrusion plant of FIG. 1. Likewise, the plant modeller of FIG. 1 can be used to control the fibre drawing plant of FIG. 11.

1. A method of constructing a control system for a real extrusion or drawing plant comprising the steps of:
a) creating a mathematical model of the plant by exciting the plant actuators and establishing the mathematical relationship between the plant inputs and outputs;
b) creating a mathematical disturbance model to represent the differences between the real plant inputs and the model outputs;
c) using the mathematical model and the disturbance model to create a mathematical model based controller; and
d) using the mathematical model based controller to control the real extrusion or drawing plant.

2. A method according to claim 1, wherein the step of using the mathematical model based controller acts in a sense to predictively control and regulate the real plant.

3. A method according to claim 1, wherein the step of using the mathematical model based controller acts to control and regulate the real plant with a predetermined range of model uncertainties.

4. A method according to claim 1, wherein the real extrusion plant is a foamed plastics extrusion plant and wherein the mathematical model of the plant has multiple inputs and multiple outputs.

5. A method according to claim 1, wherein the real extrusion plant is a solid plastics extrusion plant and wherein the mathematical model of the plant has multiple inputs and a single output.

6. A method of constructing a fault deletion system for an extrusion or drawing plant comprising the steps of:
a) inducing a fault into the plant and detecting the effect on the plant output;
b) creating a mathematical relationship between the fault and the output; and
c) monitoring the plant to detect in the plant output a characteristic indicative of the mathematical relationship.

7. A method according to claim 5, wherein the fault inducing step includes introducing a progressively worsening fault

8. A method according to claim 5 or to claim 6 wherein both the step of inducing a fault includes the step of sequentially inducing different types of faults and the step of creating a mathematical relationship comprises the step of creating successive mathematical characteristics respectively indicative of the different types of fault.

9. A method according to any preceding claim, wherein the plant comprises a filament drawing plant.

10. A method according to claim 9,wherein said filament comprises an optical fibre.
